(19) United States
(12) Patent Application Publication
(10) Pub. No.: US 2026/0309940 A1
(43) Pub. Date: Oct. 8, 2026

(54) GLASS WAVEGUIDES WITH BARRIER LAYER

(71) Applicant: CORNING INCORPORATED, CORNING, NY (US)

(72) Inventors: Lars Martin Otfried Brusberg, Potsdam (DE); Chukwudi Azubuike Okoro, Painted Post, NY (US); Aramais Robert Zakharian, Painted Post, NY (US)

(21) Appl. No.: 19/485,116

(22) PCT Filed: May 14, 2024
(86) PCT No.: PCT/US2024/029252

§ 371 Date: Nov. 17, 2025

Related U.S. Application Data
(60) Provisional application No. 63/507,571, filed on Jun. 12, 2023.

(51) Int. Cl. G02B 6/42; G02B 6/43

(52) U.S. Cl. CPC G02B 6/4239; G02B 6/4245; G02B 6/4291; G02B 6/43

(57) ABSTRACT

A waveguide assembly is provided. The waveguide assembly includes a glass substrate comprising a first waveguide, and the first waveguide is buried in the glass substrate. The waveguide assembly also comprises a second substrate comprising a second waveguide. The waveguide assembly also comprises an adhesive and a barrier layer. The first waveguide and the second waveguide are positioned proximate to each other at an optical interface with the adhesive positioned between the second substrate and the barrier layer and with the barrier layer positioned between the glass substrate and the adhesive. The barrier layer is configured to reduce the amount of alkali material migrating into the adhesive and the second substrate.

### CROSS REFERENCE TO RELATED APPLICATION

This application claims the benefit of priority under 35 U.S.C. § 119 of U.S. Provisional Application Serial No. 63/507571 filed on Jun. 12, 2023, the content of which is relied upon and incorporated herein by reference in its entirety.

### FIELD

Embodiments relate generally to glass waveguide assemblies with a barrier layer.

### BACKGROUND

Electronic packaging substrates often use a high-density organic printed circuit board material in combination with optical fiber links. To obtain higher electrical interconnect densities, silicon bridges are embedded in the organic substrate for fine-line electrical routing. Embedded polymer and glass waveguides have been demonstrated as optical interconnects to replace discrete optical fibers for photonic chip connectivity. However, where waveguide-embedded glass substrates have been used, the glass substrates often have a high content of alkali material, such as sodium ions, as is often required for integration of optical waveguides by ion-exchange. The high content of alkali materials leads to alkali poisoning where alkali material such as sodium ions migrates into interface materials (e.g., optical adhesive) and assembled integrated circuits. This migration of alkali material into the interface materials and the assembled integrated circuits leads to a reduction in optical performance for the optical interface or to a degradation in the transistor function of the integrated circuit.

Improvements in the foregoing are desired.

### SUMMARY

Various embodiments discussed herein relate to waveguide assemblies using a barrier layer to reduce the amount of migration of alkali material. Barrier layers may comprise silicon dioxide or another material, and the barrier layer may serve as a diffusion barrier that prevents migration of alkali ions such as sodium ions. The barrier layer may effectively reduce the amount of alkali migration while still supporting evanescent optical coupling of two optical waveguides on either side of the barrier layer. Additionally, the inclusion of a barrier layer allows the amount of alkali poisoning to be minimized while still allowing alkali-rich glass substrates to be used. This beneficially enables a substrate having a high content of alkali materials to be used to facilitate the integration of optical waveguides by ion-exchange.

The use of the barrier layer optimizes the reliability of transistors in integrated circuits including photonic integrated circuits (PIC) by avoiding alkali poisoning. Inclusion of barrier layers in waveguide assemblies also improves the consistency of the optical coupling performance by avoiding migration of alkali material into the optical interface layer (e.g., adhesive). The coupling efficiency between the optical waveguides in glass of a substrate and the optical waveguides in a PIC are also improved by using a barrier layer.

Barrier layers may be formed by thin film deposition in some embodiments, and deposition of the barrier layers may be done as part of the glass substrate fabrication using standard materials. Additionally, manufacturing of the waveguide assemblies contemplated herein may control the thickness of barrier layers by using techniques such as thin film deposition so that the barrier layers generally maintain a uniform thickness, and this may be beneficial to improve the amount of thermo-mechanical stress, such as may result from a coefficient of thermal expansion (CTE) mismatch between the glass substrate and the barrier layer.

Waveguide assemblies with barrier layers may be utilized in photonic packaging using glass as a packaging and optical interconnect substrate for high-performance systems like data-center switches and computer clusters.

In an example embodiment, a waveguide assembly is provided. The waveguide assembly comprises a glass substrate comprising a first waveguide, with the first waveguide being buried in the glass substrate. The waveguide assembly also comprises a second substrate comprising a second waveguide. Additionally, the waveguide assembly comprises an adhesive and a barrier layer. The first waveguide and the second waveguide are positioned proximate to each other at an optical interface with the adhesive positioned between the second substrate and the barrier layer and with the barrier layer positioned between the glass substrate and the adhesive. The barrier layer is configured to reduce the amount of alkali material migrating into the adhesive and the second substrate.

In some embodiments, the second substrate is a photonic integrated circuit chip comprising a photonic integrated circuit substrate and a silicon dioxide layer comprising silicon dioxide. The second waveguide is positioned within the silicon dioxide layer, and the silicon dioxide layer is positioned between the photonic integrated circuit substrate and the barrier layer. Furthermore, in some embodiments, the first waveguide is an ion-exchange waveguide. Additionally, in some embodiments, the adhesive is an optically clear adhesive.

In some embodiments, the barrier layer is formed through thin film deposition. In some embodiments, the barrier layer comprises silicon dioxide, silicon nitride, or an alkali-free glass material. In some embodiments, the glass substrate defines a first surface that faces the barrier layer, and the barrier layer is positioned across the entire first surface. In some embodiments, the glass substrate defines a first surface that faces the barrier layer, and the barrier layer is positioned at only a portion of the first surface that is between the first waveguide and the second waveguide. In some embodiments, the barrier layer comprises a thickness of less than 200 nanometers.

In some embodiments, the first waveguide and the second waveguide are configured to operate in a transverse electric mode, and the barrier layer comprises a material having a refractive index of less than 1.75. In some embodiments, the first waveguide and the second waveguide are configured to operate in a transverse magnetic mode, and the barrier layer comprises a material having a refractive index of less than 1.65.

In another example embodiment, a method of manufacturing a waveguide assembly is provided. The method comprises forming a barrier layer on a glass substrate comprising a first waveguide, with the barrier layer being positioned proximate to the first waveguide. The method also comprises applying an adhesive on the barrier layer. Additionally, the method comprises positioning a second substrate comprising a second waveguide relative to the adhesive so that the second waveguide is positioned proximate to the first waveguide. The barrier layer is configured to reduce the amount of alkali material migrating into the adhesive and the second substrate, and the adhesive is positioned between the barrier layer and the second substrate.

In some embodiments, the forming comprises thin film deposition. Furthermore, in some embodiments, the first waveguide is an ion-exchange waveguide. Additionally, in some embodiments, the adhesive is an optically clear adhesive. In some embodiments, the second substrate is a photonic integrated circuit chip comprising a photonic integrated circuit substrate and a silicon dioxide layer, with the silicon dioxide layer comprising silicon dioxide. The second waveguide is positioned within the silicon dioxide layer, and the silicon dioxide layer is positioned between the photonic integrated circuit substrate and the adhesive. Also, in some embodiments, the glass substrate defines a first surface that faces the barrier layer, and the barrier layer is positioned across the entire first surface. Furthermore, in some embodiments, the glass substrate defines a first surface that faces the barrier layer, and the barrier layer is positioned at only a portion of the first surface that is between the first waveguide and the second waveguide.

In another example embodiment, a waveguide assembly is provided. The waveguide assembly comprises a glass substrate comprising a first waveguide. The waveguide assembly also comprises a second substrate comprising a second waveguide. Furthermore, the waveguide assembly comprises an adhesive and a barrier layer. The first waveguide and the second waveguide are positioned proximate to each other at an optical interface with the adhesive positioned between the second substrate and the barrier layer and with the barrier layer positioned between the glass substrate and the adhesive at the optical interface. The glass substrate defines a first surface that faces the barrier layer, and the barrier layer is positioned at a portion of the first surface that is between the first waveguide and the second waveguide. The barrier layer is not positioned at a second portion of the first surface. The barrier layer is configured to reduce the amount of alkali material migrating into the adhesive and the second substrate.

In some embodiments, the barrier layer is formed through thin film deposition. In some embodiments, the barrier layer is positioned across the entire first surface. In some embodiments, the barrier layer is positioned only at the optical interface.

In some embodiments, the second substrate is a photonic integrated circuit chip comprising a photonic integrated circuit substrate and a silicon dioxide layer comprising silicon dioxide. The first waveguide is positioned within the silicon dioxide layer, and the silicon dioxide layer is positioned between the photonic integrated circuit substrate and the barrier layer. Additionally, in some embodiments, the first waveguide is an ion-exchange waveguide. Furthermore, in some embodiments, the adhesive is an optically clear adhesive. In some embodiments, the optically clear adhesive is positioned between the photonic integrated circuit chip and the barrier layer.

### BRIEF DESCRIPTION OF THE DRAWINGS

Having thus described the disclosure in general terms, reference will now be made to the accompanying drawings, which are not necessarily drawn to scale, and wherein:

FIG. 1A is a cross-sectional, schematic view illustrating an example waveguide assembly without any barrier layer provided thereon;

FIG. 1B is an enhanced view illustrating the waveguide assembly of FIG. 1A;

FIG. 2A is a cross-sectional, schematic view illustrating an example waveguide assembly having a barrier layer, in accordance with some embodiments discussed herein;

FIG. 2B is an enhanced view of the example waveguide assembly of FIG. 2A where optical interfaces are illustrated in greater detail, in accordance with some embodiments discussed herein;

FIG. 3 is a cross-sectional schematic view illustrating an example waveguide assembly having a barrier layer, in accordance with some embodiments discussed herein;

FIG. 4A is a schematic view illustrating an example first test structure having a barrier layer comprising silicon dioxide formed on a substrate, in accordance with some embodiments discussed herein;

FIG. 4B is a schematic view illustrating an example second test structure having only optical clear adhesive positioned on a substrate, in accordance with some embodiments discussed herein;

FIG. 5A is a line graph illustrating an example depth profile elemental analysis of the first test structure where the first test structure was not subjected to high temperature storage, in accordance with some embodiments discussed herein;

FIG. 5B is a line graph illustrating an example depth profile elemental analysis of the first test structure after the first test structure was subjected to high temperature storage at 300 degrees Celsius for 1000 hours, in accordance with some embodiments discussed herein;

FIG. 6A is a line graph illustrating another example depth profile elemental analysis of the first test structure where the first test structure was not subjected to any highly accelerated temperature and humidity stress test (HAST), in accordance with some embodiments discussed herein;

FIG. 6B is a line graph illustrating an example depth profile elemental analysis of the first test structure after the first test structure was subjected to HAST at 130 degrees Celsius and at a relative humidity of 85% for 1000 hours, in accordance with some embodiments discussed herein;

FIG. 7 is a line graph illustrating another example depth profile elemental analysis of test structures similar to the second test structure of FIG. 4B where the test structures were subjected to different conditions and where the substrate of test structures had different compositions, in accordance with some embodiments discussed herein;

FIG. 8A is a line graph illustrating the coupling loss of various waveguide assemblies having different designs, in accordance with some embodiments discussed herein;

FIG. 8B is a line graph illustrating the coupling loss of various waveguide assemblies having different designs, in accordance with some embodiments discussed herein;

FIG. 9A is a line graph illustrating the coupling loss of various waveguide assemblies as a function of the barrier layer thickness, in accordance with some embodiments discussed herein;

FIG. 9B is a line graph illustrating the coupling loss of various waveguide assemblies having different refractive indexes in the barrier layer, in accordance with some embodiments discussed herein; and

FIG. 10 is a flow chart illustrating an example method for manufacturing a waveguide assembly, in accordance with some embodiments discussed herein.

### DETAILED DESCRIPTION

Example embodiments of the present disclosure now will be described more fully hereinafter with reference to the accompanying drawings, in which some, but not all embodiments of the disclosure are shown. Indeed, the disclosure may be embodied in many different forms and should not be construed as limited to the example embodiments set forth herein; rather, these embodiments are provided so that this disclosure will satisfy applicable legal requirements. For all figures other than the flow chart illustrated in FIG. 10, like reference numerals generally refer to like elements throughout. For example, reference numerals 108, 208, 308 are each associated with a glass substrate. Additionally, any connections or attachments may be direct or indirect connections or attachments unless specifically noted otherwise.

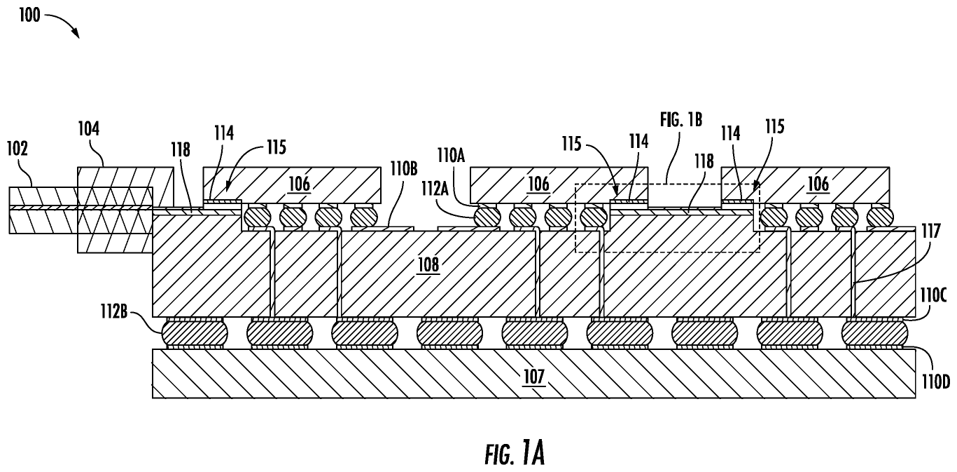

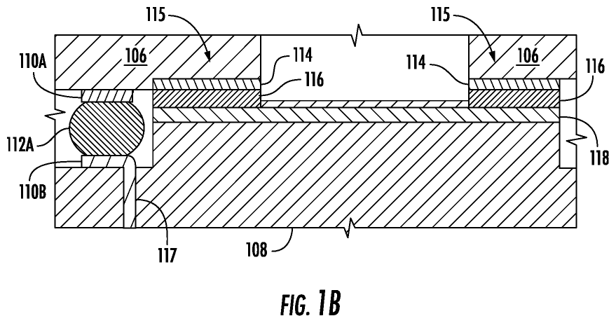

Looking first at FIG. 1A, an example waveguide assembly 100 is illustrated. An optical fiber 102 may be attached to the waveguide assembly 100 by a connector 104. Additionally, the waveguide assembly 100 comprises a glass substrate 108. Substrate waveguides 118 are included at the glass substrate 108. Three different PIC chips 106 are also included in the waveguide assembly 100. The PIC chips 106 each include PIC waveguides 114. PIC waveguides 114 may include glass waveguides, polymer waveguides, or silicon nitride waveguides. The substrate waveguides 118 are ion-exchange (IOX) waveguides embedded within glass substrate 108.

Various components are provided in electrical interfaces to assist in conducting electricity. In the illustrated embodiment, redistribution layers 110A, 110B, 110C, 110D, electrical contacts 112A, 112B, and through glass vias (TGVs) 117 are utilized. TGVs 117 and other TGVs described herein provide an electrically conductive pathway through the glass substrate 108. A first redistribution layer 110A is positioned between the first set of electrical contacts 112A and the PIC chips 106. The first redistribution layer 110A and other redistribution layers described herein provide an electrically conductive pathway, and these redistribution layers may be provided between TGVs and electrical contacts to conduct electricity between these components. The first set of electrical contacts 112A is positioned between the first redistribution layer 110A and the second redistribution layer 110B. The second redistribution layer 110B is connected to the third redistribution layer 110C using TGVs 117, and the third redistribution layer 110C is positioned so that it abuts the second set of electrical contacts 112B. The second set of electrical contacts 112B is positioned between the third redistribution layer 110C and the fourth redistribution layer 110D, and the fourth redistribution layer 110D is positioned between the second set of electrical contacts 112B and the application specific integrated circuit (ASIC) 107. While the ASIC 107 is provided in the waveguide assembly 100 in the illustrated embodiment, another component such as a PIC or some other component may be utilized in place of the ASIC 107. The electrical contacts 112A, 112B may be solder contacts or solder bumps in some embodiments. The use of these TGVs 117, redistribution layers 110A, 110B, 110C, 110D, and electrical contacts 112A, 112B may result in higher density electro-optical assemblies as compared to electro-optical assemblies having other designs.

While various components are described above to aid in conducting electricity, other components may be utilized in addition to or as an alternative to those discussed above. For example, an electrical socket, a land grid array (LGA), one or more wire bonds, an electrical conductor, a conductive adhesive, etc. may be used.

Turning now to FIG. 1B, further details regarding the optical interfaces 115 formed between the PIC chips 106 and the glass substrate 108 are illustrated. The PIC chips 106 include the PIC waveguides 114, and the glass substrate 108 includes substrate waveguides 118. PIC chips 106 may be positioned relative to the glass substrate 108 so that the PIC waveguides 114 and the substrate waveguides 118 are positioned proximate to each other. In the illustrated embodiment, the PIC waveguides 114 and the substrate waveguides 118 extend parallel to each other. Adhesive 116 is positioned between the PIC chips 106 and the glass substrate 108. The adhesive 116 may be an optical clear adhesive in some embodiments.

In the example illustrated in FIGS. 1A-1B, the PIC chips 106 within a waveguide assembly 100 are at risk of alkali poisoning due to the optical interfaces 115 with the glass substrate 108. The glass substrate 108 includes alkali materials such as sodium ions (Na), and these alkali materials tend to migrate (e.g., move) from the glass substrate 108 through the optical interfaces 115 and into integrated circuits such as the PIC chips 106. The migration of the alkali materials to the integrated circuits of the PIC chips 106 may lead to a reduction in the quality of the optical performance at the optical interfaces 115 and may also lead to degradation in transistor function of an integrated circuit in the PIC chips 106.

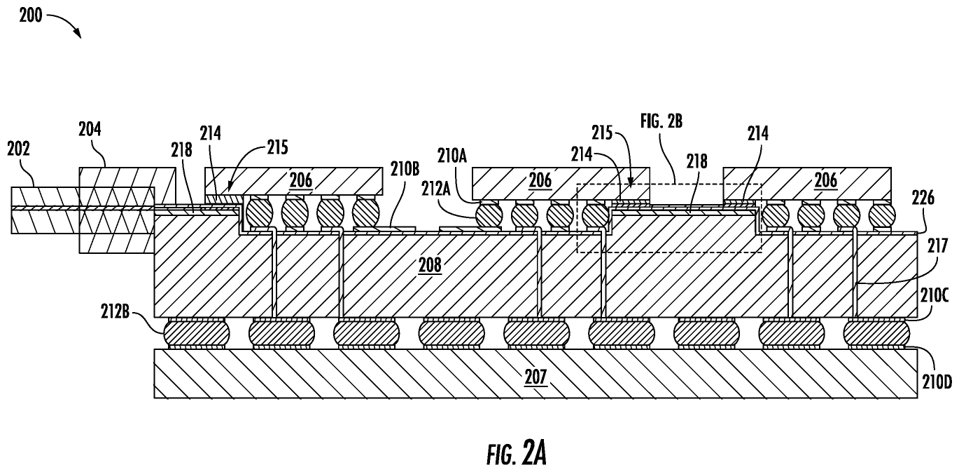

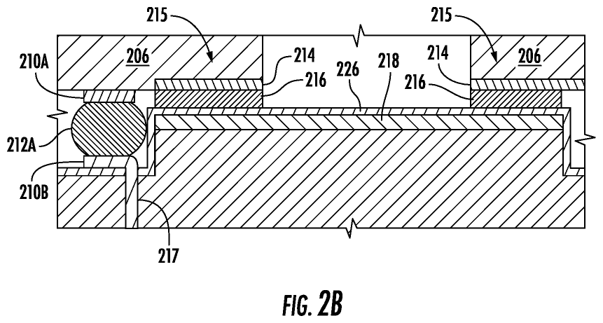

Looking now at FIG. 2A, an example waveguide assembly 200 having a barrier layer 226 is illustrated. The barrier layer 226 may be an ion-barrier layer. The inclusion of a barrier layer 226 in the waveguide assembly 200 is beneficial to help reduce the migration of alkali materials into integrated circuits and into any optical adhesive or other components attached to the glass substrate. The barrier layer 226 allows glass substrates to be utilized with high amounts of alkali materials and allows for more effective integration of ion-exchange optical waveguides to be used in glass substrates. The optical performance at the optical interface may be improved by including the barrier layer 226, and the threat of degradation in the transistor function of the integrated circuits may be reduced. The barrier layer 226 may provide these benefits while still supporting evanescent optical coupling of two optical waveguides on either side of the barrier layer 226, and the barrier layer 226 may also improve the coupling efficiency between optical waveguides.

In FIG. 2A, an optical fiber 202 is attached to the waveguide assembly 200 by a connector 204. Additionally, the waveguide assembly 200 comprises a glass substrate 208. The glass substrate 208 may be made of glass. Substrate waveguides 218 are included at the glass substrate 208. Substrate waveguides 218 may be positioned at a surface of the glass substrate 208, or substrate waveguides 218 may be embedded in the glass substrate 208. Three different PIC chips 206 are also included in the waveguide assembly 200. The PIC chips 206 each include PIC waveguides 214. PIC waveguides 214 may include glass waveguides, polymer waveguides, silicon waveguides, or silicon nitride waveguides. The substrate waveguides 218 include IOX waveguides, laser written waveguides or polymer waveguides. While PIC chips 206 are illustrated in the embodiment of FIG. 2A, various other substrates having waveguides therein may be used instead of PIC chips 206, and these substrates may include multiple layers of different materials in some embodiments.

Various components are provided in the waveguide assembly 200 to serve as an electrical interface to assist in conducting electricity. In the illustrated embodiment, redistribution layers 210A, 210B, 210C, 210D, electrical contacts 212A, 212B, and TGVs 217 are utilized. A first redistribution layer 210A is positioned between the first set of electrical contacts 212A and the PIC chips 206. The first set of electrical contacts 212A are positioned between the first redistribution layer 210A and the second redistribution layer 210B. The second redistribution layer 210B is connected to the third redistribution layer 210C using TGVs 217, and the third redistribution layer 210C is positioned so that it abuts the second set of electrical contacts 212B. The second set of electrical contacts 212B are positioned between the third redistribution layer 210C and the fourth redistribution layer 210D, and the fourth redistribution layer 210D is positioned between the second set of electrical contacts 212B and the ASIC 207. While the ASIC 207 is provided in the waveguide assembly 200 in the illustrated embodiment, another component such as a PIC or some other component may be utilized in place of the ASIC 207. The electrical contacts 212A, 212B may be solder contacts or solder bumps in some embodiments. The use of these TGVs 217, redistribution layers 210A, 210B, 210C, 210D, and electrical contacts 212A, 212B may result in higher density electro-optical assemblies.

While various components are described above to aid in conducting electricity, other components may be utilized in addition to or as an alternative to those discussed above. For example, an electrical socket, a land grid array (LGA), one or more wire bonds, an electrical conductor, a conductive adhesive, etc. may be used.

Turning now to FIG. 2B, further details regarding the optical interfaces 215 formed between the PIC chips 206 and the glass substrate 208 are illustrated. The PIC chips 206 include the PIC waveguides 214, and the glass substrate 208 includes substrate waveguides 218. The PIC chips 206 are positioned relative to the glass substrate 208 so that the PIC waveguides 214 and the substrate waveguides 218 are positioned proximate to each other at the optical interface 215. In the illustrated embodiment, the PIC waveguides 214 and the substrate waveguides 218 extend parallel to each other. Adhesive 216 is positioned between the PIC chips 206 and the barrier layer 226, and the barrier layer 226 is positioned between the adhesive 216 and the glass substrate 208. The adhesive 216 may be an optical clear adhesive in some embodiments.

The barrier layer 226 comprises silicon dioxide (SiO₂), but the barrier layer 226 may comprise silicon nitride (SiN) or an alkali-free glass material in other embodiments. Silicon dioxide has a low porosity and a high density, making silicon dioxide particularly useful in preventing unwanted migration of alkali material from glass substrates. Silicon dioxide is also beneficial to use in the barrier layer 226 because the silicon dioxide comprises dielectric material and because the silicon dioxide is easy to deposit. Silicon dioxide is also beneficial to use in the barrier layer 226 as the silicon dioxide does not significantly reduce the optical performance when a barrier layer 226 comprising silicon dioxide is positioned between waveguides at an optical interface 215. However, different materials may be provided in the barrier layer 226 in other embodiments. For example, other dielectric materials such as other silicon oxides, silicon nitride, and alkali-free glass material may be used. The barrier layer 226 is provided across the entire top surface of the glass substrate 208 as a single layer in the illustrated embodiment. However, the barrier layer 226 may be provided in only isolated locations on the top surface of the glass substrate 208 in other embodiments. For example, in some embodiments, the barrier layer 226 may be provided solely at locations proximate to the optical interfaces 215.

The barrier layer 226 may be formed through thin film deposition in some embodiments. The barrier layer 226 is configured to reduce the amount of alkali material migrating into the adhesive 216 and the PIC chip. The barrier layer 226 may include a material with a low porosity and/or a high density, and the limited number and/or size of pores may assist in reducing alkali migration through the barrier layer 226. This may be beneficial to reduce the amount of alkali poisoning even where alkali-rich glass substrates are used. This reduction in the amount of alkali poisoning may cause an improvement in the reliability of transistors in integrated circuits using PICs, an improvement in the consistency of optical coupling performance, and an improvement in the coupling efficiency between optical waveguides at the optical interface 215. Additionally, the formation of the barrier layer 226 using techniques such as thin film deposition may generally ensure a uniform thickness throughout, and this may be beneficial to improve the amount of thermo-mechanical stress, such as may, in some cases, result from a coefficient of thermal expansion (CTE) mismatch between the glass substrate and the barrier layer. Additionally, a thin layer of higher refractive index material may be used in the barrier layer improve optical coupling between a substrate waveguide 218 and a PIC chip by relaxing the coupling tolerances.

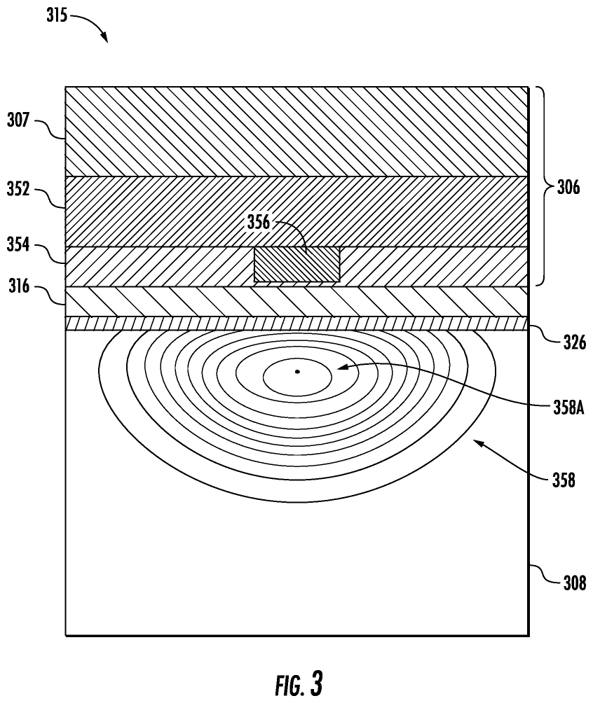

FIG. 3 is a cross-sectional schematic view illustrating an optical interface 315 of an example waveguide assembly having a barrier layer 326. In the illustrated embodiment, a glass substrate 308 comprises a waveguide 358 having a core 358A. The waveguide 358 is a single-mode (SM) IOX waveguide. The barrier layer 326 is formed on the glass substrate 308 so that the barrier layer 326 is positioned on the glass substrate 308, with the barrier layer 326 provided proximate to the waveguide 358. Adhesive 316 is applied on the barrier layer 326 so that the adhesive 316 is positioned on the barrier layer 326. A PIC chip 306 is positioned on the adhesive. The PIC chip 306 comprises a silicon dioxide (SiO₂) layer 354 that is positioned on the adhesive 316, and the silicon dioxide layer 354 comprises a waveguide 356 within the silicon dioxide layer 354. The waveguide 356 may comprise silicon nitride (SiN). The PIC chip 306 also includes a buried oxide (BOX) layer 352 that is positioned on the silicon dioxide layer 354, and the PIC chip 306 also includes a PIC substrate 307 that is positioned on the buried oxide (BOX) layer 352. The PIC substrate 307 may comprise silicon in some embodiments.

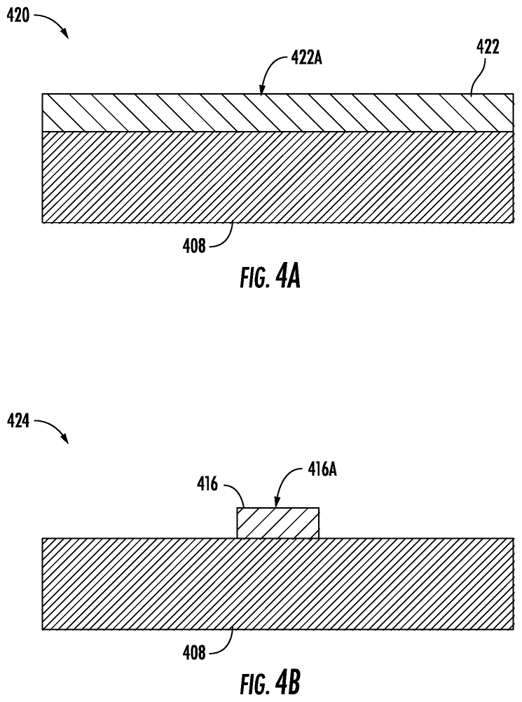

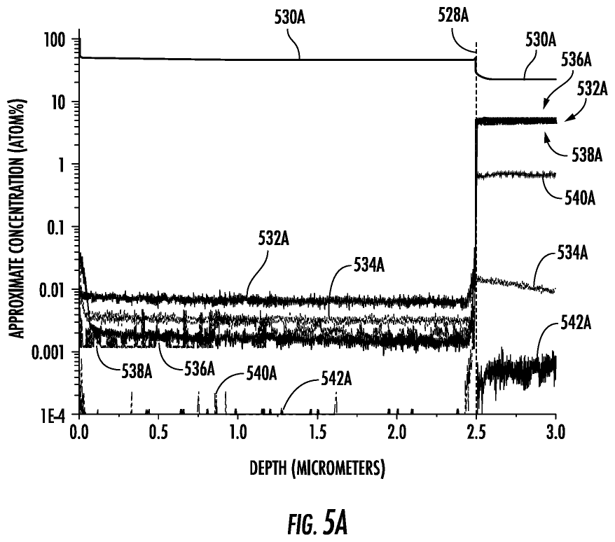

Studies have been undertaken to evaluate different approaches for mitigating the migration of alkali materials such as sodium into photonic integrated circuits in non-electrical biased environments. FIGS. 4A and 4B illustrate to example test structures that were evaluated. Looking first at FIG. 4A, a first test structure 420 is illustrated. The first test structure 420 included a barrier layer 422 on a substrate 408, with the barrier layer 422 provided in the form of a silicon dioxide (SiO₂) film. The barrier layer 422 included a surface 422A, and the barrier layer 422 comprised a thickness of approximately 2.5 micrometers. In FIG. 4B, the second test structure 424 is illustrated. The second test structure 424 included an optical clear adhesive 416 applied directly on a substrate 408. The optical clear adhesive 416 included a surface 416A. In some testing, the substrates 408 comprised Corning® IRIS™ glass, which is a glass material having alkali content. However, the substrates 408 comprised different alkali-containing glass compositions in other testing. In some embodiments, glass may comprise alkali alumino-silicate glass, alkali boro-silicate, or another alkali-containing glass.

Co-designed packages may perform at extreme environmental conditions, so testing was conducted to evaluate migration of alkali materials such as sodium when test structures were exposed to extreme environmental conditions. For example, co-designed packages are often exposed to a 300-degree Celsius temperature excursion during soldering and may have an operational temperature at the ASIC of 110 degrees Celsius. Testing was therefore performed to evaluate the amount of alkali migration in test structures where the test structures were subjected to HAST performed at 130 degrees Celsius and at a relative humidity of 85% for 1000 hours. Testing was also performed to evaluate the amount of alkali migration in a test structure where the test structure was subjected to high temperature storage at 300 degrees Celsius for 1000 hours. Control testing was also performed on test structures to evaluate the amount of alkali migration where the test structures were not subjected to extreme environmental conditions.

Depth profile elemental analyses were conducted on the test structures 420, 424 after the test structures 420, 424 were subjected to varying environmental conditions. Where any depth profile elemental analyses were conducted herein, the analyses were conducted by performing depth profiling from the surface 416A of the second test structure 424 or the surface 422A of the first test structure 420 and by proceeding in a direction normal to the respective surface towards the substrate 408. All depth profile elemental analyses conducted herein were time-of-flight secondary ion mass spectrometry (ToF-SIMS) based depth profile elemental analyses.

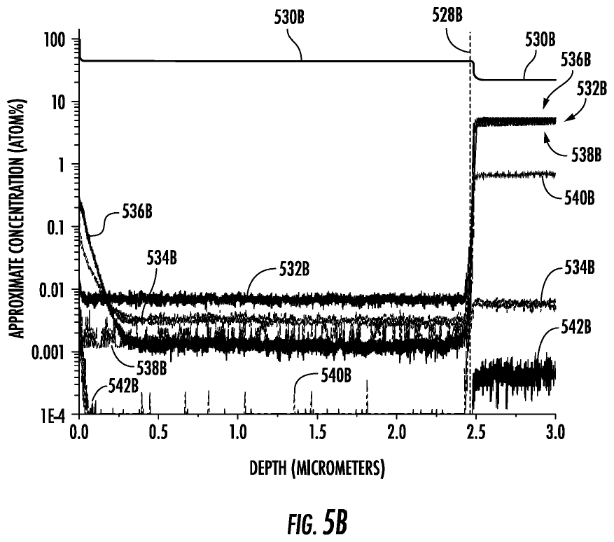

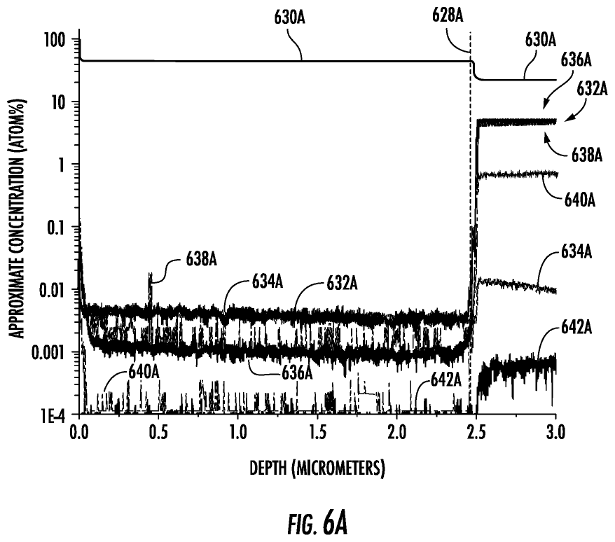

A graph illustrating the results of one depth profile elemental analysis for the first test structure 420 is illustrated in FIG. 5A. In FIG. 5A, the variable on the X-axis is the depth in micrometers, and the variable on the Y-axis is the approximate concentration in atom percentage. In FIG. 5A, testing was performed on a first test structure 420 comprising a substrate 408 with Corning® IRIS™ glass. In FIG. 5A, the first test structures 420 were not subjected to any extreme environmental conditions prior to the depth profile elemental analysis. A line 528A is included in FIG. 5A. The line 528A demarcates the boundary between the barrier layer 422 and the substrate 408 in the first test structure 420—results illustrated to the left of the line 528A illustrate compositions at locations within the barrier layer 422, and results illustrated to the right of the line 528B illustrate compositions at locations within the substrate 408.

Various plotlines are illustrated in FIG. 5A to show the compositions of various materials. For example, a silicon plotline 530A, an aluminum plotline 532A, a potassium plotline 534A, a sodium plotline 536A, a boron plotline 538A, a magnesium plotline 540A, and a lithium plotline 542A are illustrated in FIG. 5A. At locations within the barrier layer 422 (to the left of the line 528A), the silicon plotline 530A generally remained around 50 percent in atomic percentage, the aluminum plotline 532A generally remained around 0.007 percent in atomic percentage, the potassium plotline 534A generally remained around 0.0035 percent in atomic percentage, the sodium plotline 536A generally remained around 0.002 percent in atomic percentage, the boron plotline 538A generally remained around 0.002 percent in atomic percentage, the magnesium plotline 540A generally remained around zero in atomic percentage, and the lithium plotline 542A generally remained around zero in atomic percentage. However, some variations were present in each of the plotlines, especially at the boundaries of the barrier layer 422. For example, increased traces of potassium and sodium are illustrated in the potassium plotline 534A and the sodium plotline 536A respectively at depths of less than 0.25 micrometers.

At locations within the substrate 408 (to the right of the line 528A), the silicon plotline 530A generally remained between 20 percent and 30 percent in atomic percentage, the aluminum plotline 532A generally remained around 5 percent in atomic percentage, the potassium plotline 534A was approximately 0.015 percent in atomic percentage at the line 528A and gradually decreased to approximately 0.009 percent in atomic percentage at a depth of 3.0 micrometers, the sodium plotline 536A generally remained around 5 percent in atomic percentage, the boron plotline 538A generally remained around 5 percent in atomic percentage, the magnesium plotline 540A generally remained around 0.7 in atomic percentage, and the lithium plotline 542A generally remained at low levels ranging from 0.0001 percent to 0.001 percent in atomic percentage.

Turning now to FIG. 5B, a line graph is provided illustrating an example depth profile elemental analysis of the first test structure 420 after the first test structure 420 was subjected to high temperature storage at 300 degrees Celsius for 1000 hours. In FIG. 5B, the variable on the X-axis is the depth in micrometers, and the variable on the Y-axis is the approximate concentration in atom percentage. In FIG. 5B, testing was performed on a first test structure 420 comprising a substrate 408 with a Corning® IRIS™ glass. A line 528B is included in FIG. 5B. The line 528B demarcates the boundary between the barrier layer 422 and the substrate 408 in the first test structure 420—results illustrated to the left of the line 528B illustrate compositions at locations within the barrier layer 422, and results illustrated to the right of the line 528B illustrate compositions at locations within the substrate 408.

Various plotlines are illustrated in FIG. 5B to show the compositions of various materials. For example, a silicon plotline 530B, an aluminum plotline 532B, a potassium plotline 534B, a sodium plotline 536B, a boron plotline 538B, a magnesium plotline 540B, and a lithium plotline 542B are illustrated in FIG. 5B. At locations within the barrier layer 422 (to the left of the line 528B), the silicon plotline 530B generally remained between 40 percent and 50 percent in atomic percentage, the aluminum plotline 532B generally remained around 0.007 percent in atomic percentage, the boron plotline 538B generally remained around 0.002 percent in atomic percentage. However, some variations were present in the plotlines. The potassium plotline 534B generally remained around 0.0035 percent in atomic percentage at depths between 0.25 micrometers and the 2.45 micrometers, and the potassium plotline 534B had higher atomic percentages increasing up to approximately 0.1 percent at depths of less than 0.25 micrometers. The sodium plotline 536B generally remained around 0.0015 percent in atomic percentage at depths between 0.375 micrometers and 2.45 micrometers, and the sodium plotline 536B had higher atomic percentages increasing up to approximately 0.3 percent at depths of less than 0.375 micrometers. The magnesium plotline 540B generally remained around zero in atomic percentage at depths between 0.05 micrometers and 2.45 micrometers, and the magnesium plotline 540B increased to approximately 0.007 percent at a depth of zero. The lithium plotline 542B generally remained around zero in atomic percentage at depths between 0.05 micrometers and 2.45 micrometers, and the magnesium plotline 540B was approximately 0.001 percent at a depth of zero.

At locations within the substrate 408 (to the right of the line 528B), the silicon plotline 530B generally remained slightly above 20 percent in atomic percentage, the aluminum plotline 532B generally remained around 5 percent in atomic percentage, the potassium plotline 534B generally remained around 0.006 percent in atomic percentage, the sodium plotline 536B generally remained around 5 percent in atomic percentage, the boron plotline 538B generally remained around 5 percent in atomic percentage, the magnesium plotline 540B generally remained around 0.7 in atomic percentage, and the lithium plotline 542B generally remained around 0.0004 percent in atomic percentage.

The results in FIGS. 5A and 5B show that very small amounts of sodium were detected in the barrier layer 422 (see FIG. 4A) in both cases. This illustrates that the barrier layer 422 was effective at inhibiting the migration of sodium material into the barrier layer 422. The results in FIGS. 5A and 5B generally show similar sodium content levels in the barrier layer 422, indicating that the barrier layer 422 is effective even in high temperature storage conditions. The increased traces of sodium at depths of less than 0.125 micrometers in FIG. 5A and at depths less than 0.375 micrometers in FIG. 5B are believed to be due to contamination from other handling and environmental chamber conditions during testing and not due to sodium migration from the substrate 408, and this is because the increased levels of sodium were present proximate to the surface 422A (see FIG. 4A) rather than at the interface between the barrier layer 422 (see FIG. 4A) and the substrate 408 (see FIG. 4A).

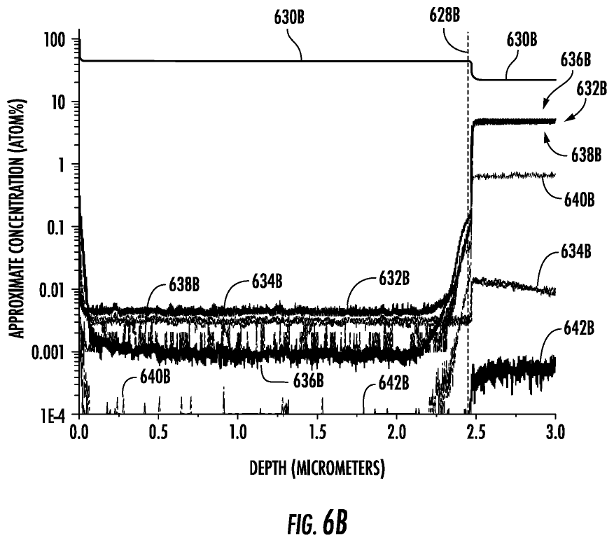

A graph illustrating the results of another depth profile elemental analysis for the first test structure 420 is illustrated in FIG. 6A. In FIG. 6A, testing was performed on a first test structure 420 of FIG. 4A where the first test structure 420 comprised a substrate 408 with Corning® IRIS™ glass. In FIG. 6A, the first test structures 420 were not subjected to any additional environmental conditions (e.g., increased temperatures, highly accelerated temperatures, and humidity stress testing, etc.). The depth profile elemental analysis was conducted by performing depth profiling from the surface 422A of the barrier layer 422 and by proceeding in a direction normal to the surface 422A towards the substrate 408. A line 628A is included in FIG. 6A. In FIG. 6A, the variable on the X-axis is the depth in micrometers, and the variable on the Y-axis is the approximate concentration in atom percentage. The line 628A demarcates the boundary between the barrier layer 422 and the substrate 408 in the first test structure 420—results illustrated to the left of the line 628A illustrate compositions at locations within the barrier layer 422, and results illustrated to the right of the line 628B illustrate compositions at locations within the substrate 408.

Various plotlines are illustrated in FIG. 6A to show the compositions of various materials. For example, a silicon plotline 630A, an aluminum plotline 632A, a potassium plotline 634A, a sodium plotline 636A, a boron plotline 638A, a magnesium plotline 640A, and a lithium plotline 642A are illustrated in FIG. 6A. To the left of the line 628A, the silicon plotline 630A generally remained around 50 percent in atomic percentage, the aluminum plotline 632A generally remained around 0.004 percent in atomic percentage, the boron plotline 638A generally remained around 0.002 percent in atomic percentage, and the lithium plotline 642A generally remained around zero in atomic percentage. However, some variations were present in each of the plotlines, especially at the boundaries of the barrier layer 422. The potassium plotline 634A generally remained around 0.004 percent in atomic percentage at depths ranging between 0.05 micrometers and 2.45 micrometers, and the potassium plotline 634A was approximately 0.1 percent in atomic percentage at a depth of zero. The sodium plotline 636A generally remained around 0.001 percent in atomic percentage at depths ranging between 0.1 micrometers and 2.45 micrometers, and the sodium plotline 636A was approximately 0.1 percent in atomic percentage at a depth of zero. Additionally, the magnesium plotline 640A generally remained around 0.00015 percent in atomic percentage at depths ranging between 0.05 micrometers and 2.45 micrometers, and the magnesium plotline 640A was approximately 0.005 percent in atomic percentage at a depth of zero.

To the right of the line 628A, the silicon plotline 630A generally remained between 20 percent and 30 percent in atomic percentage, the aluminum plotline 632A generally remained around 5 percent in atomic percentage, the potassium plotline 634A was approximately 0.015 percent in atomic percentage at the line 628A and gradually decreased to approximately 0.009 percent in atomic percentage at a depth of 3.0 micrometers, the sodium plotline 636A generally remained around 5 percent in atomic percentage, the boron plotline 638A generally remained around 5 percent in atomic percentage, the magnesium plotline 640A generally remained around 0.7 in atomic percentage, and the lithium plotline 642A generally remained at low levels ranging from 0.0001 to 0.001 percent in atomic percentage.

Turning now to FIG. 6B, a line graph is provided illustrating an example depth profile elemental analysis of a test structure after the test structure was subjected to HAST at 130 degrees Celsius and at a relative humidity of 85% for 1000 hours. In FIG. 6B, the variable on the X-axis is the depth in micrometers, and the variable on the Y-axis is the approximate concentration in atom percentage. In FIG. 6B, testing was performed on a first test structure 420 (see FIG. 4A) where the first test structure 420 comprised a substrate 408 with Corning® IRIS™ glass. The depth profile elemental analysis was conducted by performing depth profiling from the surface 422A and by proceeding in a direction normal to the surface 422A towards the substrate 408. A line 628B is included in FIG. 6B. The line 628B demarcates the boundary between the barrier layer 422 and the substrate 408 in the first test structure 420—results illustrated to the left of the line 628B illustrate compositions at locations within the barrier layer 422, and results illustrated to the right of the line 628B illustrate compositions at locations within the substrate 408.

Various plotlines are illustrated in FIG. 6B to show the compositions of various materials. For example, a silicon plotline 630B, an aluminum plotline 632B, a potassium plotline 634B, a sodium plotline 636B, a boron plotline 638B, a magnesium plotline 640B, and a lithium plotline 642B are illustrated in FIG. 6B. To the left of the line 628B, the silicon plotline 630B generally remained between 40 percent and 50 percent in atomic percentage. Additionally, the aluminum plotline 632B generally remained around 0.0045 percent in atomic percentage for depths ranging between zero and 2.25 micrometers, and the aluminum plotline 632B increased to around 0.1 percent in atomic percentage at a depth of 2.45 micrometers. The potassium plotline 634B begins at around 0.1 percent in atomic percentage at a depth of zero, the potassium plotline 634B decreases to an atomic percentage of around 0.0045 percent in atomic percentage at a depth of 0.25 micrometers, the potassium plotline 634B generally remained at an atomic percentage of approximately 0.0045 percent in atomic percentage at depths ranging from 0.25 micrometers to 2.25 micrometers, and the potassium plotline 634B had higher atomic percentages increasing up to approximately 0.2 percent at depths of approximately 2.45 micrometers. The sodium plotline 636B begins at around 0.1 percent in atomic percentage at a depth of zero, the sodium plotline 636B decreases to an atomic percentage of around 0.001 percent in atomic percentage at a depth of 0.375 micrometers, the sodium plotline 636B generally remained around 0.001 percent in atomic percentage at depths between 0.375 micrometers and 2.125 micrometers, and the sodium plotline 636B had higher atomic percentages increasing up to approximately 0.2 percent at depths of approximately 2.45 micrometers. The boron plotline 638B generally remained between 0.001 percent and 0.002 percent in atomic percentage at depths ranging from zero to 2.25 micrometers, and the boron plotline 638B increased to approximately 0.1 percent at 2.45 micrometers. However, some variations were present in the plotlines. The magnesium plotline 640B begins at approximately 0.006 percent at a depth of zero, the magnesium plotline 640B generally remained around zero in atomic percentage at depths between 0.05 micrometers and 2.20 micrometers, and the magnesium plotline 640B increased to approximately 0.015 percent at a depth of 2.45 micrometers. The lithium plotline 642B began around approximately 0.001 percent at a depth of zero, and the lithium plotline 642B generally remained around zero in atomic percentage at depths between 0.05 micrometers and 2.45 micrometers.

To the right of the line 628B, the silicon plotline 630B generally remained slightly above 20 percent in atomic percentage, the aluminum plotline 632B generally remained around 5 percent in atomic percentage, the potassium plotline 634B began around 0.015 percent and decreased to around 0.009 percent in atomic percentage, the sodium plotline 636B generally remained around 5 percent in atomic percentage, the boron plotline 638B generally remained around 5 percent in atomic percentage, the magnesium plotline 640B generally remained around 0.7 in atomic percentage, and the lithium plotline 642B generally remained around levels of less than 0.0008 percent in atomic percentage.

The results in FIGS. 6A-6B show that very small amounts of sodium were detected in the barrier layer 422 (see FIG. 4A) in both the control conditions and the HAST conditions, showing that the barrier layer 422 was effective at inhibiting the migration of sodium material into the barrier layer 422. By preventing the migration of sodium material into the barrier layer 422, the barrier layer 422 is also effective at preventing sodium material from migrating past the barrier layer 422 and into other components such as adhesive 216 (see FIG. 2A), PIC chips 206 (see FIG. 2A), or transistors in the PIC chips 206. Thus, the barrier layer 422 may assist in preventing or reducing the likelihood of alkali poisoning. For the reasons provided herein, the increased traces of sodium at depths of less than 0.125 micrometers in FIGS. 6A and 6B are believed to be due to contamination and not due to sodium migration from the substrate 408. The increases in sodium content at depths between 2.125 micrometers and 2.45 micrometers are attributable to thickness variation in the barrier layer that was applied rather than ion migration—this is believed to be the case because other materials such as magnesium, aluminum, and boron also showed increases in concentrations at depths between 2.125 micrometers and 2.45 micrometers.

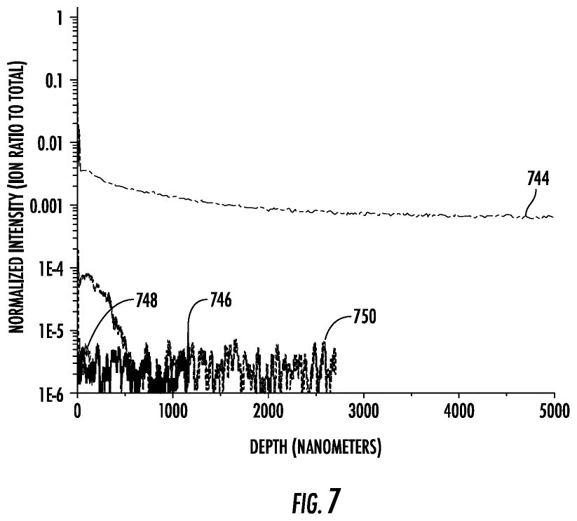

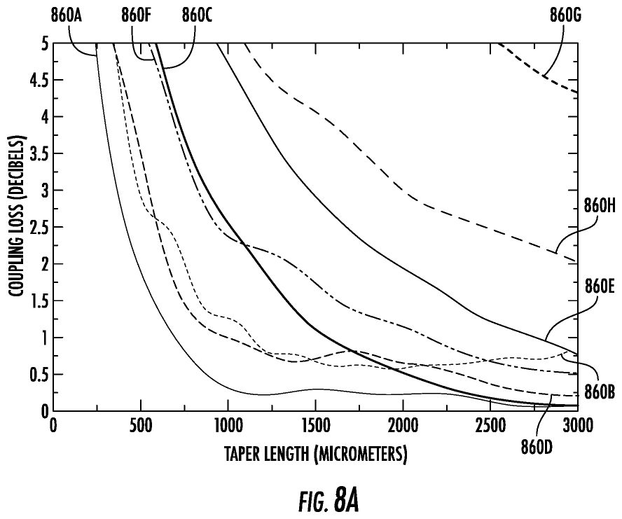

Depth profile elemental analyses were also conducted on the second test structure 424 of FIG. 4B, and the results of the depth profile elemental analyses are illustrated in FIG. 7. In FIG. 7, the variable on the X-axis is the depth in nanometers, and the variable on the Y-axis is the normalized intensity. The normalized intensity was calculated based on the ratio of the number of sodium ions to the total number of ions.

In FIG. 7, the first plotline 744 represents data for detected sodium ion content where the second test structure 424 comprised a substrate containing Corning® IRIS™ glass that underwent HAST at 130 degrees Celsius and 85% relative humidity for 1000 hours. The second plotline 746 represents data for detected sodium ion content where the second test structure 424 comprised a substrate containing Corning® IRIS™ glass that did not undergo any further HAST. The third plotline 748 represents data for detected sodium ion content where the second test structure 424 comprised a substrate containing an HPFS 7980 composition that underwent HAST at 130 degrees Celsius and 85% relative humidity for 1000 hours. The fourth plotline 750 represents data for detected sodium ion content where the second test structure 424 comprised a substrate containing an HPFS 7980 composition that did not undergo any further HAST testing. The HPFS 7980 compositions did not have any alkali content, while the Corning® IRIS™ glass did possess alkali content.

As illustrated in FIG. 7, the results show that the sodium ion content was the highest in the first plotline 744. In the first plotline 744, the sodium ion content was around 0.02 in normalized intensity at a depth of zero. The sodium ion content decreased to a normalized intensity of around 0.0035 at depths of a few nanometers, and the sodium ion content gradually decreased to a normalized intensity of around 0.0007 at depths of 5000 nanometers.

The significant amount of sodium content in the adhesive of the test structure suggests that the sodium material migrated from the rich alkali-containing substrate into the adhesive. Thus, the results for the first plotline 744 show that, where no barrier layer is present between a glass substrate and an adhesive, the risk of alkali poisoning at the adhesive is high under potential operating conditions. The alkali poisoning of the adhesive may also lead to alkali poisoning of other components adjacent to the adhesive such as a PIC chip 206 (see FIG. 2A).

The first plotline 744 showed significantly higher sodium content than the second plotline 746. For the second plotline 746, the sodium ion content remained at normalized intensity levels of less than 1.5E-5 for depths ranging from 0 nanometers to 1130 nanometers.

For the third plotline 748 and the fourth plotline 750, the sodium content was also significantly lower than the first plotline 744. For the third plotline 748, the sodium ion content was around 1E-4 in normalized intensity at a depth of zero. The sodium ion content decreased to around 2E-6 in normalized intensity at a depth of just a few nanometers, and the sodium ion content generally remained between 6 E-6 and 1E-6 in normalized intensity at greater depths up to a depth of around 130 micrometers. For the fourth plotline 750, the sodium ion content was around 7E-5 in normalized intensity at a depth of zero. The sodium ion content increased slightly to 8E-5 in normalized intensity at a depth of around 130 nanometers, and the sodium ion content then decreased to normalized intensities ranging between 1E-6 and 7E-6 at depths of 500 nanometers to 2750 nanometers.

The third plotline 748 and the fourth plotline 750 both showed similar sodium levels. Both the third plotline 748 and the fourth plotline 750 show data for test structures having a substrate containing an HPFS 7980 composition. The similarities in the third plotline 748 and the fourth plotline 750 were likely due to the lack of alkali content in the HPFS 7980 composition.

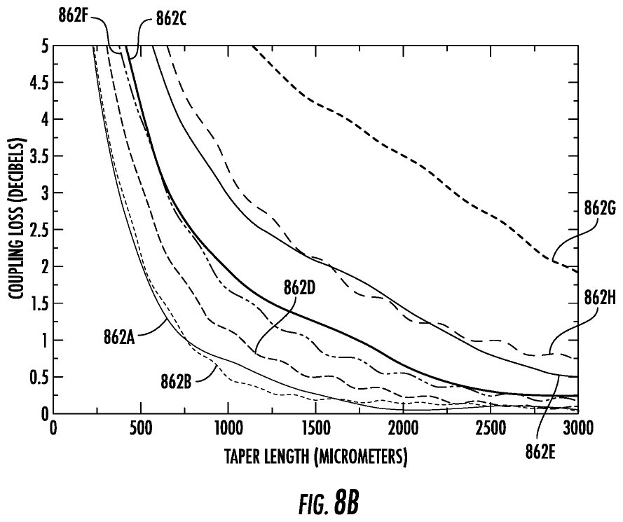

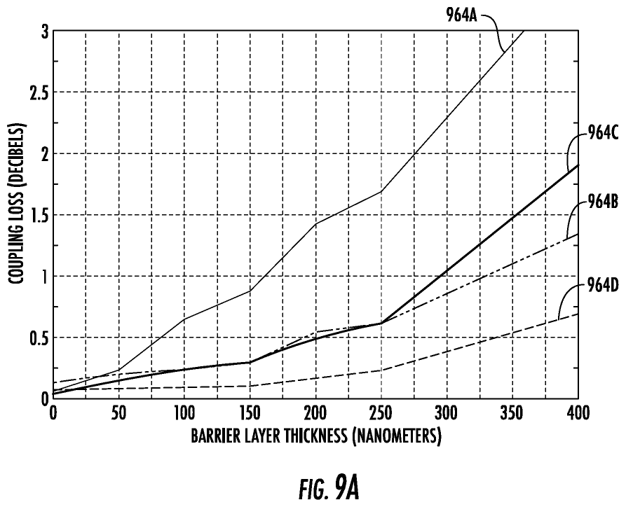

FIG. 8A is a line graph illustrating the coupling loss of various waveguide assemblies having different designs. The coupling losses shown in FIG. 8A are the total coupling losses and not just the coupling losses attributable to the barrier layer. Data for the line graph of FIG. 8A was obtained using designs optimized for coupling at 1310 nanometers with an adhesive thickness of 0.5 micrometers and with a refractive index of 1.5019 for the adhesive. The SiN waveguide tapered section length is provided as the variable on the X-axis in FIG. 8A with the units being in micrometers, and the coupling loss is provided as the variable on the Y-axis with the units for coupling loss being in decibels. FIG. 8A reveals that the coupling losses were smaller where the barrier layer thickness was smaller and that coupling losses were generally smaller where the taper length was increased. FIG. 8A also reveals that coupling losses of under 1 decibel or even under 0.5 decibels were possible where the appropriate mode polarization (e.g., transverse electric mode or transverse magnetic mode), taper length, and barrier layer thickness are selected.

The first plotline 860A represents data for a barrier layer having a thickness of 0 nanometers where waveguides were operating in a transverse electric mode. The first plotline 860A begins with a coupling loss of 5 decibels around a taper length of 500 micrometers. The first plotline 860A gradually decreased to a coupling loss of around 0.5 decibels around a taper length of 875 micrometers, and the coupling loss decreased further to a value lower than 0.125 decibels at a taper length of 3000 micrometers.

The second plotline 860B represents data for a barrier layer having a thickness of 0 nanometers where waveguides were operating in a transverse magnetic mode. The second plotline 860B begins with a coupling loss of 5 decibels around a taper length of 350 micrometers. The second plotline 860B gradually decreased to a coupling loss of around 1 decibel around a taper length of 1125 micrometers, and the second plotline 860B remained at coupling losses between 0.5 decibels and 1 decibel at taper lengths between 1125 micrometers and 3000 micrometers.

The third plotline 860C represents data for a barrier layer having a thickness of 100 nanometers where waveguides were operating in a transverse electric mode. The third plotline 860C begins with a coupling loss of 5 decibels around a taper length of 600 micrometers. The third plotline 860C gradually decreased to a coupling loss of around 1 decibel around 1550 micrometers, and the third plotline 860C decreased further to a coupling loss of 0.5 decibels around 2000 micrometers. The coupling loss decreased further to a value lower than 0.125 decibels at a taper length of 3000 micrometers.

The fourth plotline 860D represents data for a barrier layer having a thickness of 100 nanometers where waveguides were operating in a transverse magnetic mode. The fourth plotline 860D begins with a coupling loss of 5 decibels around a taper length of 350 micrometers. The fourth plotline 860D gradually decreased to a coupling loss of 1 decibel around a taper length of 1000 micrometers. The fourth plotline 860D continued to decrease to a coupling loss of 0.5 decibels around a taper length of 2300 micrometers, and the fourth plotline 860D continued to decrease to a coupling loss of less than 0.25 decibels at a taper length of 3000 micrometers.

The fifth plotline 860E represents data for a barrier layer having a thickness of 200 nanometers where waveguides were operating in a transverse electric mode. The fifth plotline 860E begins with a coupling loss of 5 decibels around a taper length of 950 micrometers. The fifth plotline 860E gradually decreased to a coupling loss of 1 decibel around a taper length of 2750 micrometers, and the fifth plotline 860E decreased further to a coupling loss of around 0.75 decibels at a taper length of 3000 micrometers. The coupling loss remained above 0.5 decibels for all taper lengths ranging between zero micrometers and 3000 micrometers for the fifth plotline 860E.

The sixth plotline 860F represents data for a barrier layer having a thickness of 200 nanometers where waveguides were operating in a transverse magnetic mode. The sixth plotline 860F begins with a coupling loss of 5 decibels around a taper length of 550 micrometers. The sixth plotline 860F gradually decreased to a coupling loss of 1 decibel around a taper length of 2125 micrometers, and the sixth plotline 860F gradually decreased further to a coupling loss of about 0.5 decibels around a taper length of 3000.

The seventh plotline 860G represents data for a barrier layer having a thickness of 400 nanometers where waveguides were operating in a transverse electric mode. The seventh plotline 860G begins with a coupling loss of 5 decibels around a taper length of 2550 micrometers, and the seventh plotline 860G gradually decreased to a coupling loss of around 4.35 decibels at a taper length of 3000 micrometers. The coupling loss remained above 4.25 decibels for all taper lengths ranging between zero micrometers and 3000 micrometers for the seventh plotline 860G.

The eighth plotline 860H represents data for a barrier layer having a thickness of 400 nanometers where waveguides were operating in a transverse magnetic mode. The eighth plotline 860H begins with a coupling loss of 5 decibels around a taper length of 1100 micrometers, and the eight plotline 860H gradually decreased to a coupling loss of around 2 decibels at a taper length of 3000 micrometers. The coupling loss generally remained above 2 decibels for all taper lengths ranging between zero micrometers and 3000 micrometers for the eight plotline 860H.

FIG. 8B is a line graph illustrating the coupling loss of various waveguide assemblies having different designs. The coupling losses shown in FIG. 8B are the total coupling losses and not just the coupling losses attributable to the barrier layer. Data for the line graph of FIG. 8B was obtained using designs optimized for coupling at 1310 nanometers with an adhesive thickness of 0.5 micrometers and with a refractive index of 1.4779 for the adhesive. Data for the line graph of FIG. 8B was also obtained using an optical interface with IOX waveguides and SiN waveguides. The SiN waveguide tapered section length is provided as the variable on the X-axis in FIG. 8B with the units being in micrometers, and the coupling loss is provided as the variable on the Y-axis with the units for coupling loss being in decibels. FIG. 8B reveals that the coupling losses were smaller where the barrier layer thickness was smaller and that coupling losses were generally smaller where the taper length was increased. FIG. 8B also reveals that coupling losses of under 1 decibel or even under 0.5 decibels were possible where the appropriate mode, taper length, and barrier layer thickness are selected.

The refractive index of the barrier layer is lower than the refractive index of the substrate. Where this is the case, the overlap between the IOX and SiN waveguide mode fields may be reduced, and longer SiN waveguide tapered section lengths may be utilized compared to other designs without the barrier layer. The impact is particularly pronounced for barrier layer thickness values of greater than 200 nanometers. For smaller thicknesses, the coupling loss of less than 0.5 decibels can still be achieved with SiN waveguide tapered section lengths of 2.5-3 mm.

The first plotline 862A represents data where a barrier layer having a thickness of zero nanometers was used and where waveguides were operating in a transverse electric mode. The first plotline 862A begins with a coupling loss of 5 decibels around a taper length of 225 micrometers. The first plotline 862A gradually decreased to a coupling loss of around 1 decibel around a taper length of 750 micrometers, and the first plotline 862A decreased to a coupling loss of around 0.5 decibels around a taper length of 1175 micrometers, and the coupling loss decreased further to less than 0.125 decibels at a taper length of 3000 micrometers.

The second plotline 862B represents data where a barrier layer having a thickness of zero nanometers was used and where waveguides were operating in a transverse magnetic mode. The second plotline 862B begins with a coupling loss of 5 decibels around a taper length of 225 micrometers. The second plotline 862B gradually decreased to a coupling loss of 1 decibel around a taper length of 750 micrometers. The second plotline 862B gradually decreased to a coupling loss of 0.5 decibels around a taper length of 1000 micrometers, and the coupling loss decreased to less than 0.125 decibels at a taper length of 3000 micrometers.

The third plotline 862C represents data where a barrier layer having a thickness of 100 nanometers was used and where waveguides were operating in a transverse electric mode. The third plotline 862C begins with a coupling loss of 5 decibels around a taper length of 400 micrometers. The third plotline 862C gradually decreased to a coupling loss of 1 decibel around 1750 micrometers, and the third plotline 862C decreased further to a coupling loss of 0.5 decibels around 2125 micrometers, and the third plotline 862C continued to decrease to a coupling loss of about 0.25 decibels at a taper length of 3000 micrometers.

The fourth plotline 862D represents data where a barrier layer having a thickness of 100 nanometers was used and where waveguides were operating in a transverse magnetic mode. The fourth plotline 862D begins with a coupling loss of 5 decibels around a taper length of 315 micrometers. The fourth plotline 862D gradually decreased to a coupling loss of 1 decibel around a taper length of 1100 micrometers. The fourth plotline 862D continued to decrease to a coupling loss of 0.5 decibels around a taper length of 1500 micrometers, and the fourth plotline 862D continued to decrease to a coupling loss of less than 0.25 decibels at a taper length of 3000 micrometers.

The fifth plotline 862E represents data where a barrier layer having a thickness of 200 nanometers was used and where waveguides were operating in a transverse electric mode. The fifth plotline 862E begins with a coupling loss of 5 decibels around a taper length of 600 micrometers. The fifth plotline 862E gradually decreased to a coupling loss of 1 decibel around a taper length of 2350 micrometers, and the fifth plotline 862E decreased further to a coupling loss of around 0.5 decibels at a taper length of 3000 micrometers.

The sixth plotline 862F represents data where a barrier layer having a thickness of 200 nanometers was used and where waveguides were operating in a transverse magnetic mode. The sixth plotline 862F begins with a coupling loss of 5 decibels around a taper length of 375 micrometers. The sixth plotline 862F gradually decreased to a coupling loss of 1 decibel around a taper length of 1500 micrometers, and the sixth plotline 862F gradually decreased further to a coupling loss of about 0.5 decibels around a taper length of 2000 micrometers. The sixth plotline 862F gradually decreased further to a coupling loss of less than 0.25 decibels at the taper length of 3000 micrometers.

The seventh plotline 862G represents data where a barrier layer having a thickness of 400 nanometers was used and where waveguides were operating in a transverse electric mode. The seventh plotline 862G begins with a coupling loss of 5 decibels around a taper length of 1150 micrometers, and the seventh plotline 862G gradually decreased to a coupling loss of around 1.8 decibels at a taper length of 3000 micrometers. The coupling loss remained above 1.75 decibels for all taper lengths ranging between zero micrometers and 3000 micrometers for the seventh plotline 862G.

The eighth plotline 862H represents data where a barrier layer having a thickness of 400 nanometers was used and where waveguides were operating in a transverse magnetic mode. The eighth plotline 862H begins with a coupling loss of 5 decibels around a taper length of 650 micrometers. The eighth plotline 862H gradually decreased to a coupling loss of 1 decibel around a taper length of 2500, and the eight plotline 862H decreased further to a coupling loss of around 0.75 decibels at a taper length of 3000 micrometers. The coupling loss remained above 0.5 decibels for all taper lengths ranging between zero micrometers and 3000 micrometers for the eight plotline 862H.

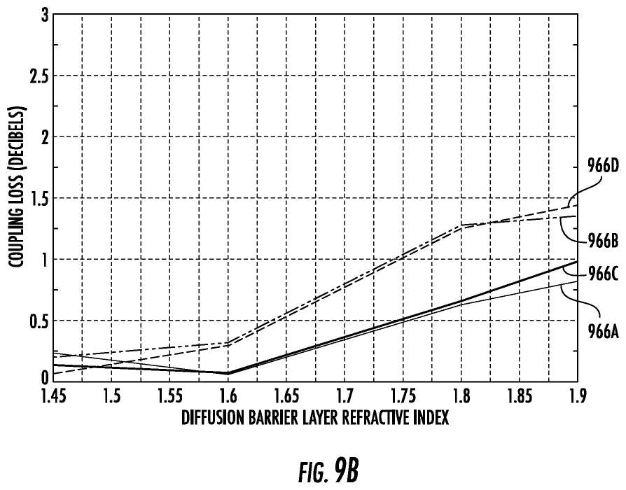

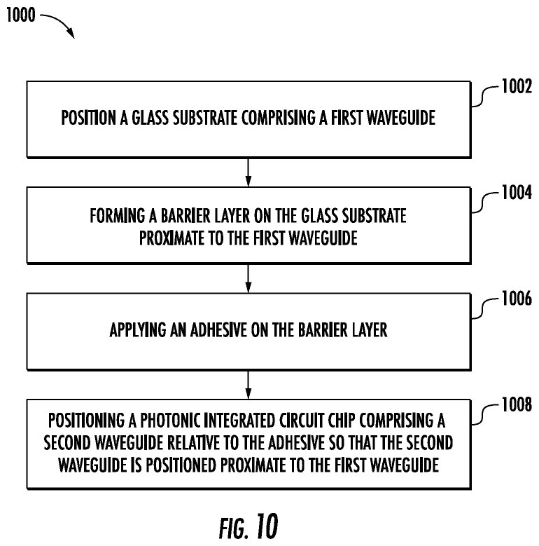

FIG. 9A is a line graph illustrating the coupling loss of various waveguide assemblies as a function of the barrier layer thickness where the barrier layer included silicon dioxide material. The coupling losses shown in FIG. 9A are the total coupling losses and not just the coupling losses attributable to the barrier layer. In the line graph of FIG. 9A, the thickness of the barrier layer is the variable on the X-axis, with the thickness being provided in nanometers. Additionally, the coupling loss is the variable on the Y-axis, with the coupling loss being provided in decibels.

The first plotline 964A represents data for the coupling loss where the SiN waveguides had a tapered section length of 2000 micrometers and where waveguides were operating in a transverse electric mode. The second plotline 964B represents data where the SiN waveguides had a tapered section length of 2000 micrometers and where waveguides were operating in a transverse magnetic mode. The third plotline 964C represents data where the SiN waveguides had a tapered section length of 3000 micrometers where waveguides were operating in a transverse electric mode. The fourth plotline 964D represents data where the SiN waveguides had a tapered section length of 3000 micrometers and where waveguides were operating in a transverse magnetic mode.

The first plotline 964A generally maintained the highest coupling losses regardless of the thickness of the barrier layer. The fourth plotline 964D generally maintained the lowest coupling losses regardless of the thickness of the barrier layer. The second plotline 964B and the third plotline 964C generally maintained the similar coupling losses where the thickness was less than 250 nanometers. However, at thicknesses of greater than 250 nanometers, the coupling losses in the second plotline 964B were lower than the coupling losses of the third plotline. The results show that the coupling loss increases significantly as the barrier layer thickness increases, and this is believed to be due to the increased distance separating waveguides at an optical interface.

Turning now to FIG. 9B, a line graph is illustrated showing the relationship between the coupling loss and the refractive index of a barrier layer where various waveguide assemblies were used. In the line graph of FIG. 9B, the refractive index of the barrier layer is the variable on the X-axis. Additionally, the coupling loss is the variable on the Y-axis, with the coupling loss being provided in decibels. The coupling losses shown in FIG. 9B are the total coupling losses and not just the coupling losses attributable to the barrier layer. The first plotline 966A represents data where the SiN waveguides had a tapered section length of 2000 micrometers and where waveguides were operating in a transverse electric mode. The second plotline 966B represents data where the SiN waveguides had a tapered section length of 2000 micrometers and where waveguides were operating in a transverse magnetic mode. The third plotline 966C represents data where the SiN waveguides had a tapered section length of 3000 micrometers and where waveguides were operating in a transverse electric mode. The fourth plotline 966D represents data where the SiN waveguides had a tapered section length of 3000 micrometers where waveguides were operating in a transverse magnetic mode.

Where the refractive index was greater than 1.525, the plotlines 966B, 966D associated with waveguides operating in the transverse magnetic mode had higher coupling losses than the plotlines 966A, 966C associated with waveguides operating in the transverse electric mode. The plotlines 966B, 966D associated with waveguides operating in the transverse magnetic mode increased continuously from the refractive index of 1.45 all the way to the refractive index of 1.9. By contrast, the plotlines 966A, 966C associated with waveguides operating in the transverse electric mode showed decreases in the coupling losses from a refractive index of 1.45 to a refractive index of 1.6, and these plotlines 966A, 966C showed increases in the coupling losses from a refractive index of 1.6 to a refractive index of 1.9. The increases in coupling losses as the refractive index increased past 1.6 may be attributable to the presence of guided modes in the barrier layer that interfere with coupling, and barrier layers with larger refractive indexes and/or larger thicknesses may support guided modes that interfere with the direct coupling from IOX to SiN, increasing the coupling loss. FIG. 9B indicates that a refractive index of approximately 1.6 may be beneficial to minimize the coupling loss where waveguides are operating in a transverse electric mode. At these refractive indexes proximate to 1.6, the waveguide mode overlap between IOX and SiN modes may be increased relative to designs where the refractive index is 1.45. Where waveguides are operating in a transverse magnetic mode, lower refractive indexes closer to 1.45 or lower may be beneficial to minimize the coupling loss. In FIG. 9B, a refractive index of approximately 1.45 corresponds to a wavelength of 1310 nanometers for a barrier layer including silicon dioxide.

FIG. 10 is a flow chart illustrating an example method 1000 for manufacturing a waveguide assembly. At operation 1002, a glass substrate comprising a first waveguide is positioned. The first waveguide may be an IOX waveguide. In some embodiments, the glass substrate defines a first surface that faces a barrier layer.

At operation 1004, the barrier layer is formed on the glass substrate proximate to the first waveguide. Thin film deposition may be used to form the barrier layer on the glass substrate proximate to the first waveguide. In some embodiments, the barrier layer is positioned across the entire adjacent surface of the glass substrate. However, the barrier layer may instead be formed at certain locations on the glass substrate without being formed at other locations in other embodiments, such as at optical interfaces. At operation 1006, an adhesive is applied on the barrier layer. The adhesive may be an optically clear adhesive. As used herein, an optically clear adhesive is an adhesive that is in an optical path, has a defined refractive index, high transmission, and makes a reliable bond between components. Suitable optically clear adhesives include Norland Optical Adhesive 60 available from Norland Products Inc. in Jamesburg, NJ, USA, Dymax OP-60, available from Dymax® in Torrington, CT, USA, and NTT GA700H, available from NTT Advanced Technology Corporation in Tokyo, Japan.

At operation 1008, a PIC chip comprising a second waveguide is positioned relative to the adhesive so that the second waveguide is positioned proximate to the first waveguide. The PIC chip may comprise a PIC substrate and a silicon dioxide layer comprising silicon dioxide, with the second waveguide being positioned within the silicon dioxide layer and with the silicon dioxide layer being positioned between the PIC substrate and the adhesive. The PIC substrate may comprise silicon.

In the method 1000, the barrier layer reduces the amount of alkali material extending into the PIC chip and the adhesive. By doing so, the benefits described herein are obtained. The operations of method 1000 may be performed in different orders, and certain operations may be performed simultaneously in some embodiments. For example, operation 1006 may be performed either before or after operation 1008 in some embodiments. Where operation 1006 is performed after operation 1008, adhesive may be dispensed by filling the gap by capillary force so that adhesive is positioned between the first waveguide and the second waveguide. Additionally, in some embodiments, certain operations of the method 1000 may be omitted or additional operations may be added to the method 1000. For example, the waveguide assembly formed by method 1000 may undergo a curing operation after operations 1006, 1008.

Many modifications and other embodiments set forth herein will come to mind to one skilled in the art to which these embodiments pertain having the benefit of the teachings presented in the foregoing descriptions and the associated drawings. Therefore, the disclosure is not limited to the specific embodiments disclosed and modifications and other embodiments are intended to be included within the scope of the disclosure. Moreover, although the foregoing descriptions and the associated drawings describe example embodiments in the context of certain example combinations of elements and/or functions, different combinations of elements and/or functions may be provided by alternative embodiments without departing from the scope of the disclosure. In this regard, different combinations of elements and/or functions than those explicitly described above are also contemplated within the scope of the disclosure. Although specific terms are employed herein, they are used in a generic and descriptive sense only and not for purposes of limitation.

1. A waveguide assembly, the waveguide assembly comprising:
a glass substrate comprising a first waveguide buried in the glass substrate;
a second substrate comprising a second waveguide;
an adhesive;
a barrier layer;
wherein the first waveguide and the second waveguide are positioned proximate to each other at an optical interface with the adhesive positioned between the second substrate and the barrier layer and with the barrier layer positioned between the glass substrate and the adhesive, the barrier layer configured to reduce the amount of alkali material migrating into the adhesive and the second substrate.

2. The waveguide assembly of claim 1, wherein the barrier layer is formed through thin film deposition.

3. The waveguide assembly of claim 1, wherein the barrier layer comprises silicon dioxide, silicon nitride, or an alkali-free glass material.

4. The waveguide assembly of claim 1, wherein the second substrate is a photonic integrated circuit chip comprising a photonic integrated circuit substrate and a silicon dioxide layer comprising silicon dioxide, the second waveguide positioned within the silicon dioxide layer, and the silicon dioxide layer positioned between the photonic integrated circuit substrate and the barrier layer.

5. The waveguide assembly of claim 4, wherein the first waveguide is an ion-exchange waveguide.

6. The waveguide assembly of claim 4, wherein the adhesive is an optically clear adhesive.

7. The waveguide assembly of claim 1, wherein the glass substrate comprises a first surface that faces the barrier layer, and the barrier layer is positioned across the entire first surface.

8. The waveguide assembly of claim 1, wherein the glass substrate comprises a first surface that faces the barrier layer, and the barrier layer is positioned at a portion of the first surface that is between the first waveguide and the second waveguide.

9. The waveguide assembly of claim 1, wherein a thickness of the barrier layer is less than 200 nanometers.

10. The waveguide assembly of claim 1, wherein the first waveguide and the second waveguide are configured to operate in a transverse electric mode, and the barrier layer comprises a material having a refractive index of less than 1.75.

11. The waveguide assembly of claim 1, wherein the first waveguide and the second waveguide are configured to operate in a transverse magnetic mode, and the barrier layer comprises a material having a refractive index of less than 1.65.

12. A method of manufacturing a waveguide assembly, the method comprising:
forming a barrier layer on a glass substrate comprising a first waveguide, the barrier layer is positioned proximate the first waveguide;
applying an adhesive on the barrier layer;
positioning a second substrate comprising a second waveguide relative to the adhesive so that the second waveguide is positioned proximate the first waveguide; and
wherein the barrier layer is configured to reduce the amount of alkali material migrating into the adhesive and the second substrate, and the adhesive is positioned between the barrier layer and the second substrate.

13. The method of claim 12, wherein the forming comprises thin film deposition.

14. The method of claim 12, wherein the first waveguide is an ion-exchange waveguide.

15. The method of claim 12, wherein the adhesive is an optically clear adhesive.

16. The method of claim 12, wherein the second substrate is a photonic integrated circuit chip comprising a photonic integrated circuit substrate and a silicon dioxide layer comprising silicon dioxide, the second waveguide positioned within the silicon dioxide layer, and the silicon dioxide layer positioned between the photonic integrated circuit substrate and the adhesive.

17. The method of claim 12, wherein the glass substrate comprises a first surface that faces the barrier layer, and the barrier layer is positioned across the entire first surface.

18. The method of claim 12, wherein the glass substrate comprises a first surface that faces the barrier layer, and the barrier layer is positioned at only a portion of the first surface that is between the first waveguide and the second waveguide.

19. A waveguide assembly, the waveguide assembly comprising:
a glass substrate comprising a first waveguide;
a second substrate comprising a second waveguide;
an adhesive;
a barrier layer; and
wherein the first waveguide and the second waveguide are positioned proximate each other at an optical interface with the adhesive positioned between the second substrate and the barrier layer and with the barrier layer positioned between the glass substrate and the adhesive at the optical interface, wherein the glass substrate defines a first surface that faces the barrier layer, the barrier layer is positioned at a portion of the first surface that is between the first waveguide and the second waveguide, the barrier layer is not positioned at a second portion of the first surface, and the barrier layer is configured to reduce the amount of alkali material migrating into the adhesive and the second substrate.

20. The waveguide assembly of claim 19, wherein the barrier layer is formed through thin film deposition.

21. The waveguide assembly of claim 19, wherein the second substrate is a photonic integrated circuit chip comprising a photonic integrated circuit substrate and a silicon dioxide layer comprising silicon dioxide, the first waveguide positioned within the silicon dioxide layer, and the silicon dioxide layer positioned between the photonic integrated circuit substrate and the barrier layer.

22. The waveguide assembly of claim 21, wherein the first waveguide is an ion-exchange waveguide.

23. The waveguide assembly of claim 21, wherein the adhesive is an optically clear adhesive.

24. The waveguide assembly of claim 23, wherein the optically clear adhesive is positioned between the photonic integrated circuit chip and the barrier layer.

25. The waveguide assembly of claim 19, wherein the barrier layer is positioned across the entire first surface.

26. The waveguide assembly of claim 19, wherein the barrier layer is positioned at the optical interface.
